(19) United States
(12) Patent Application Publication
(10) Pub. No.: US 2009/0302792 A1
(43) Pub. Date: Dec. 10, 2009

(54) AC rotating machine with improved drive for its stator coil

(75) Inventors: Masahiko Osada, Okazaki-shi (JP); Shigeyuki Morimoto, Nagoya (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/457,386

(22) Filed: Jun. 9, 2009

(30) Foreign Application Priority Data
Jun. 10, 2008 (JP) 2008-151721

(51) Int. Cl. H02P 6/14; H02K 3/28; H02H 7/08; H02P 25/08

(52) U.S. Cl. 318/400.21; 310/202; 318/400.29; 318/701

(57) ABSTRACT

In an AC rotating machine, a stator is provided with N-phase stator windings and located relative to the rotor. The N is an integer equal to or greater than 3, and the N-phase stator windings are arranged to be electrically isolated from each other. An inverter circuit is provided with first to N-th full-bridge inverters. Each of the first to N-th full-bridge inverters includes a first pair of series-connected switching elements and a second pair of series-connected switching elements. The first pair of series-connected switching elements and the second pair of series-connected switching elements are connected in parallel to each other. Each of the first to N-th full-bridge inverters is configured to individually apply a single-phase AC voltage to a corresponding one of the N-phase stator windings to thereby create a torque that rotates the rotor.

### CROSS REFERENCE TO RELATED APPLICATIONS

This application is based on Japanese Patent Application 2008-151721 filed on Jun. 10, 2008. This application claims the benefit of priority from the Japanese Patent Application, so that the descriptions of which are all incorporated herein by reference.

### FIELD OF THE INVENTION

The present invention relates to AC (Alternating Current) rotating machines having a stator coil and a rotor in relation thereto and designed to energize the stator coil to rotate the rotor.

### BACKGROUND OF THE INVENTION

As examples of various types of AC rotating machines, synchronous motors have been used for wide industrial fields as high-efficiency motors. This is because they have advantages of: eliminating a complicated commutation mechanism with difficult maintenance relative to DC (Direct Current) motors; and reducing secondary copper loss of the rotor as compared with induction motors.

These synchronous motors include permanent magnet synchronous motors (PMSMs), field-coil synchronous motors, synchronous reluctance motors, switched reluctance motors (SRS), and the like. Because the synchronous reluctance motors and switched-reluctance motors normally have a salient-pole structure, the remaining types of synchronous motors provide lower torque ripples and/or lower vibrations. In addition, because some types of synchronous motors have internal magnets, they provide a higher torque relative to another type of synchronous motors. Such switched reluctance motors are disclosed in, for example, Japanese Patent Application Publication No. 2000-312500.

When a synchronous motor to be installed in an apparatus is required to generate a torque equal to or greater than a preset level, a three-phase synchronous motor with a delta- or star-connected three-phase stator coil to be driven by three-phase AC voltages is normally used. This is because, if a single-phase or two-phase synchronous motor were used, torque ripples would be increased. In addition, if a synchronous motor with a number of phases greater than five were used, toque ripples would be reduced, but the structure of an inverter circuit installed in the apparatus for applying the three-phase AC voltages to the synchronous motor and the structure of the three-phase windings of the synchronous motor would be complicated. These complicated structures of the synchronous motor and the inverter circuit would increase the total manufacturing cost of the apparatus.

As an inverter for driving a three-phase synchronous motor, a three-phase inverter circuit is normally used. A three-phase inverter circuit is provided with parallelly connected half-bride inverters for respective three-phases. The half-bridge inverter for each phase consists of an upper arm power switching element and a lower arm power switching element connected thereto in series. Such a three-phase inverter circuit is operative to apply three-phase AC voltages to the delta- or star-connected stator coil of the three-phase synchronous motor to thereby drive the three-phase synchronous motor.

Hybrid vehicles or electric vehicles require an electric power storage device, such as a battery, as a power source to be installed therein. Such an electric power storage device has a limited electric power chargeable therein. This increases the importance of reduction in the total motor loss. For this reason, as described above, synchronous motors are preferably installed in hybrid vehicles or electric vehicles as power generation motors therefor.

These types of AC motors, such as these synchronous motors, to be installed in motor vehicles, such as hybrid vehicles or electric vehicles, require a higher reliability as compared with other types of AC motors in view of failure prevention during vehicle running. These types of AC motors to be installed in motor vehicle also require more increase in torque to be created thereby in view of vehicle lightweight.

### SUMMARY OF THE INVENTION

In view of the foregoing circumstances, an object of at least one aspect of the present invention is to provide AC rotating machines, which are designed to provide a higher reliability, and more increase in torque to be created thereby as compared with conventional AC rotating machines.

According to one aspect of the present invention, there is provided an alternating current (AC) rotating machine. The AC rotating machine includes a rotor, and a stator provided with N-phase stator windings and located relative to the rotor. The N is an integer equal to or greater than 3, and the N-phase stator windings are arranged to be electrically isolated from each other. The AC rotating machine includes an inverter circuit provided with first to N-th full-bridge inverters. Each of the first to N-th full-bridge inverters includes a first pair of series-connected switching elements and a second pair of series-connected switching elements. The first pair of series-connected switching elements and the second pair of series-connected switching elements are connected in parallel to each other. Each of the first to N-th full-bridge inverters is configured to individual apply a single-phase AC voltage to a corresponding one of the N-phase stator windings to thereby create a torque that rotates the rotor.

Specifically, the AC rotating machine according to the one aspect provides the first to N-th full-bridge inverters as the inverter circuit for the electrically isolated N-phase stator windings. Each of the first to N-th full-bridge inverters includes, as a first half-bridge, the first pair of series-connected switching elements and, as a second half-bridge, the second pair of series-connected switching elements. The first and second half-bridges are parallelly connected to each other. Each of the first to N-th full-bridge inverters is configured to individually drive a corresponding one of the N-phase stator windings.

The configuration of the AC rotating machine according to the one aspect of the present invention allows a set of one phase winding and a corresponding one full-bridge inverter to be electrically little affected from the remaining (N-1) sets of (N-1)-phase stator windings and corresponding full-bridge inverters except for the one full-bridge inverter.

Thus, the AC rotating machine improves the reliability of a motor composed of the stator and the rotor while keeping the increase in the manufacturing cost of the inverter circuit.

In the first preferred embodiment of the one aspect, the N is three, the N-phase stator windings are three-phase stator windings, the inverter circuit is provided with the first to third full-bridge inverters, and each of the first to third full-bridge inverters is configured to individually apply the single-phase AC voltage to a corresponding one of the three-phase stator windings. The three-phase stator windings are first-, second-, and third-phase stator windings, the first-phase stator winding and the first full-bridge inverter are connected to each other to constitute a first-phase circuit system, the second-phase stator winding and the second full-bridge inverter are connected to each other to constitute a second-phase circuit system, and the third-phase stator winding and the third full-bridge inverter are connected to each other to constitute a third-phase circuit system.

A fault determining unit is configured to determine whether a fault exists in one of the first to third-phase circuit systems. A control unit deactivates one of the first to third full-bridge inverters when it is determined that the fault exists in the one of the first to third-phase circuit systems, the one of the first to third full-bridge inverters corresponding to the one of the first to third-phase circuit systems in which the fault exists. The control unit also causes the remaining two of the first to third full-bridge inverters to continuously apply the single-phase AC voltages to corresponding two of the three-phase stator windings except for one-phase stator winding, the one-phase stator winding being included in the one of the first to third-phase circuit systems.

According to the first preferred embodiment, it is possible to continuously drive the motor even in the event of a fault of one-phase circuit system. Thus, the AC rotating machine of the preferred embodiment improves the reliability thereof even in the event of a failure of one-phase circuit system.

In the second preferred embodiment of the one aspect, a fault determining unit is configured to determine whether a fault exists in one of the first to third-phase circuit systems. A control unit deactivates one of the first to third full-bridge inverters when it is determined that the fault exists in the one of the first to third-phase circuit systems, the one of the first to third full-bridge inverters corresponding to the one of the first to third-phase circuit systems in which the fault exists. The control unit lo causes the remaining two of the first to third full-bridge inverters to continuously apply the single-phase AC voltages to corresponding two of the three-phase stator windings except for one-phase stator winding. The one-phase stator winding is included in the one of the first to third-phase circuit systems.

According to the second preferred embodiment, it is possible to continuously drive the motor even in the event of a fault of each of two-phase circuit systems. Thus, the AC rotating machine according to the second preferred embodiment improves the reliability thereof even in the event of a failure of each of two-phase circuit systems.

In the third preferred embodiment of the one aspect, the first to third full-bridge inverters are configured to individually apply the single-phase AC voltages to the three-phase stator windings, respectively, the single-phase AC voltages are shifted by a predetermined electric angle in phase from each other to constitute three-phase AC voltages. As compared with a conventional three-phase inverter for applying three-phase sinusoidal AC voltages to star-connected phase windings of a synchronous motor, it is possible for the inverter circuit to increase the level of three-phase AC voltages to be applied to the three-phase windings. This can increase the number of turns of each of the three-phase windings so as to reduce each of three-phase currents without reducing torque to be created by the three-phase windings. This reduces copper loss due to the three-phase currents to be applied to the three-phase windings. The configuration of the inverter circuit also prevents circulating currents to thereby reduce power loss and heat in the motor due to the circulating currents.

In the fourth preferred embodiment of the one aspect, the first to third full-bridge inverters are configured to individually apply the single-phase AC voltages to the three-phase stator windings, respectively, such that a vector sum of the single-phase AC voltages applied from the respective first to third full-bridge inverters is unequal to zero.

Specifically, the AC rotating machine according to the fourth aspect is adapted to individually control the first to third full-bridge inverters to thereby apply, to each of the three-phase windings, a phase current most suitable thereto.

In contrast, conventional AC rotating machines each with star- or delta-connected stator windings cannot inherently apply, to each of the star- or delta-connected stator windings, a phase current most suitable thereto. This is because the vector sum of the three-phase voltages to be outputted from a conventional three-phase inverter becomes zero.

In the fifth preferred embodiment of the one aspect, the motor is a reluctance motor with a salient-pole structure, and the torque created by the three-phase stator windings to which the single-phase AC voltages are individually applied, respectively, is a synchronous reluctance torque based on the salient-pole structure. Each of the first to third full-bridge inverters is configured to apply a non-sinusoidal phase current based on the single-phase AC voltage to each of the three-phase stator windings during a preset phase period in which an absolute value of derivative of an inductance of a corresponding phase winding is higher than a preset value. The non-sinusoidal phase current is the sum of a fundamental sinusoidal current component and higher-order current components.

Thus, the AC rotating machine according to the fifth preferred embodiment provides a higher torque as compared with conventional AC rotating machines.

According to another aspect of the present invention, there is provided an AC rotating machine. The AC rotating machine includes a rotor and a stator provided with first N-phase stator windings and second N-phase stator windings. The stator is located relative to the rotor, and the N is an integer equal to or greater than 3. The first N-phase stator windings are arranged to be electrically isolated from each other. The AC rotating machine includes a first inverter circuit provided with first to N-th full-bridge inverters for the first N-phase stator windings, and a second inverter circuit provided with first to N-th inverters for the second N-phase stator windings. Each of the first to N-th full-bridge inverters of the first inverter circuit includes a first pair of series-connected switching elements and a second pair of series-connected switching elements. The first pair of series-connected switching elements and the second pair of series-connected switching elements are connected in parallel to each other. Each of the first to N-th full-bridge inverters of the first inverter circuit is configured to individually apply a single-phase AC voltage to a corresponding one of the first N-phase stator windings to energize the first N-phase stator windings. The first to N-th inverters of the second inverter circuit are configured to apply N-phase AC voltages to the second N-phase stator windings to energize the second N-phase stator windings, respectively. The energized first N-phase stator windings and the energized second N-phase stator windings create a torque that rotates the rotor.

According to another aspect of the present invention, it is possible to improve the reliability of the AC rotating machine even in the event of a failure of either the first inverter circuit, the second inverter circuit, the first N-phase stator windings, and the second N-phase stator windings.

### BRIEF DESCRIPTION OF THE DRAWINGS

Other objects and aspects of the invention will become apparent from the following description of embodiments with reference to the accompanying drawings in which:

FIG. 1 is a circuit diagram of an example of the structure of an AC motor system according to the first embodiment of the present invention;

FIG. 2 is a circuit diagram schematically illustrating an example of the structure of a conventional AC motor system in which a conventional three-phase inverter applies three-phase AC voltages to a conventional delta-connected stator coil;

FIG. 3 is a circuit diagram schematically illustrating the set of individually coupled U-phase winding 11 and first full-bridge inverter, the set of individually coupled V-phase winding and second full-bridge inverter, and the set of individually coupled W-phase winding and third full-bridge inverter according to the first embodiment of the present invention;

FIG. 4 is a flowchart schematically illustrating a fault-tolerance routine to be executed by a controller illustrated in FIG. 1 according to the first embodiment of the present invention;

FIG. 5 is a flowchart schematically illustrating a high-torque generation routine to be executed by a controller illustrated in FIG. 1 according to the first embodiment of the present invention; and

FIG. 6 is a circuit diagram of an example of the structure of an AC motor system according to the second embodiment of the present invention.

### DETAILED DESCRIPTION OF EMBODIMENTS OF THE INVENTION

Embodiments of the present invention will be described hereinafter with reference to the accompanying drawings. The present invention is however not limited to the following embodiments, and the subject matter of the present invention can be achieved by the combination of known components except for components of the embodiments.

In each of the embodiments, the present invention is, for example, applied to an AC motor system installed in a motor vehicle, such as a hybrid vehicle or an electric vehicle.

### First Embodiment

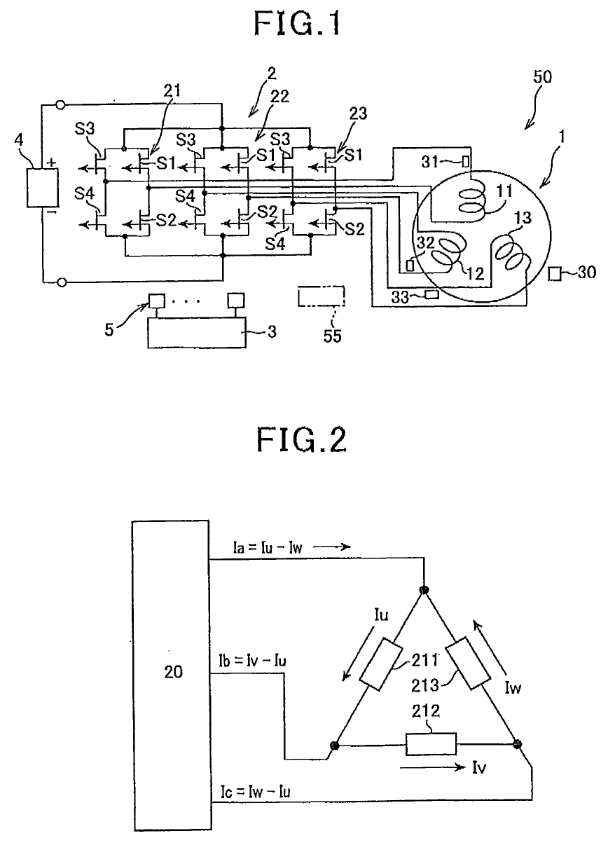

An example of the structure of an AC motor system 50 according to the first embodiment of the present invention is illustrated in FIG. 1. Referring to FIG. 1, the AC motor system 50 includes a three-phase synchronous motor 1, an inverter circuit 2, a motor controller 3, a direct current (DC) power source 4, and a plurality of drivers 5.

The three-phase synchronous motor, referred to simply as “synchronous motor”, 1 is designed to be driven by AC voltages. For example, a synchronous reluctance motor or a permanent magnet synchronous motor can be used as the three-phase synchronous motor 1.

When the synchronous motor 1 is installed in a hybrid vehicle, it is directly or indirectly coupled to a crankshaft of an engine installed in the hybrid vehicle, and serves as a power source together with the engine. When the synchronous motor 1 is installed in an electric vehicle, it serves as a power source of the electric vehicle.

When the synchronous motor 1 is a three-phase synchronous reluctance motor, the rotor has a salient-pole structure. For example, the rotor core of the rotor is formed with first to fourth groups of chordal flux barriers punched out in slit by, for example, press working. The first to fourth groups of the flux barriers are symmetrically arranged with respect to the axial direction of the rotor such that:

each of the first to fourth groups of the flux barriers is circumferentially spaced apart from another adjacent group thereof;

the flux barriers of each of the first to fourth groups are aligned in a corresponding radial direction of the rotor core at intervals therebetween; and

both ends of each of the flux barriers of each of the first to fourth groups extend toward the outer periphery of the rotor core with predetermined thin edges thereof left between the both ends and the outer periphery.

The first to fourth groups of the flux barriers provide thin magnetic paths therebetween. The tin edges of the rotor core are continued to each other; this supports the thin magnetic paths.

A direct axis (d-axis) and a quadrature axis (q-axis) are defined in the rotor as a rotating coordinate system (two-phase rotor coordinate system) such that the q-axis has a phase being π/2 radian electric angle leading with respect to a corresponding d-axis during rotation of the rotor. The d-axis has a high magnetic permeability, and the q-axis has a low magnetic permeability because of the flux barriers.

The configuration of the synchronous reluctance motor creates a reluctance torque based on the difference between the magnetic impedance in the d-axis and that in the q-axis, thus rotating the rotor.

When the synchronous motor 1 is a three-phase permanent magnet synchronous motor, the rotor core of the rotor is provided at its circumferential portions with at lest one pair of permanent magnets. The permanent magnets of the at least one pair are, for example, so embedded in the outer periphery of the rotor core as to be symmetrically arranged with respect to the center axis of the rotor core at regular intervals in a circumferential direction of the rotor core.

One permanent magnet of the at least one pair has a north pole (N pole) directed radially outward away from the center of the rotor core. The other permanent magnet has a south pole (S pole) directed radially outward away from the center of the rotor core.

The rotor has a direct axis (d-axis) in line with a direction of magnetic flux created by the N pole, in other words, in line with a rotor N pole center line. The rotor also has a quadrature axis (q-axis) with a phase being π/2 radian electric angle leading with respect to a corresponding d-axis during rotation of the rotor. The d and q axes constitute a d-q coordinate system (two-phase rotating coordinate system) defined in the rotor of the synchronous motor 1.

The synchronous motor 1 is also provided with a stator. The stator includes a stator core with, for example, an annular shape in its lateral cross section. The stator core is disposed in relation to the rotor, for example, disposed around the outer periphery of the rotor core such that the inner periphery of the stator core is opposite to the outer periphery of the rotor core with a predetermined air gap.

For example, the stator core also has a plurality of slots. The slots are formed through the stator core and are circumferentially arranged at given intervals. The stator also includes three-phase stator windings (U-, V-, and W-phase windings) 11, 12, and 13. Each of the three-phase stator windings, referred to simply as “three-phase windings”, 11, 12, and 13 is individually wound concentratedly or distributedly in the slots of the stator such that the U-, V-, and W-phase windings are shifted by an electric angle of, for example, 2π/3 radian in phase from each other. Each of the three-phase windings 11, 12, and 13 constitutes an individual stator coil of the synchronous motor 1.

The inverter circuit 2 is designed as a three-phase inverter circuit. Specifically, the inverter circuit 2 is provided with a first full-bridge inverter 21, a second full-bridge inverter 22, and a third full-bridge inverter 23. Each of the full-bridge inverters 21, 22, and 23 consists of series-connected switching elements, such as power, transistors, S1 and S2, and series-connected switching elements, such as power transistors, S3 and S4.

A connecting point between the switching elements S1 and S2 of the first full-bridge inverter 21 is connected to one end of the U-phase winding 11, and a connecting point between the switching elements S3 and S4 of the first full-bridge inverter 21 is connected to the other end of the U-phase winding 11. Similarly, a connecting point between the switching elements S1 and S2 of the second full-bridge inverter 22 is connected to one end of the V-phase winding 12, and a connecting point between the switching elements S3 and S4 of the second full-bridge inverter 22 is connected to the other end of the V-phase winding 12. In addition, a connecting point between the switching elements S1 and S2 of the third full-bridge inverter 23 is connected to one end of the W-phase winding 13, and a connecting point between the switching elements S3 and S4 of the third full-bridge inverter 23 is connected to the other end of the W-phase winding 13.

One end of the series-connected switching elements S1 and S2 and one end of the series-connected switching elements S3 and S4 of the first full-bridge inverter 21 are commonly connected to each other to constitute a positive terminal of the first full-bridge inverter 21. The other end of the series-connected switching elements S1 and S2 and the other end of the series-connected switching elements S3 and S4 of the first full-bridge inverter 21 are commonly connected to each other to constitute a negative terminal for the first full-bridge inverter 21.

Similarly, one end of the series-connected switching elements S1 and S2 and one end of the series-connected switching elements S3 and S4 of the second full-bridge inverter 22 are commonly connected to each other to constitute a positive terminal of the second full-bridge inverter 22. The other end of the series-connected switching elements S1 and S2 and the other end of the series-connected switching elements S3 and S4 of the second full-bridge inverter 22 are commonly connected to each other to constitute a negative terminal for the second full-bridge inverter 22.

In addition, one end of the series-connected switching elements S1 and S2 and one end-of the series-connected switching elements S3 and S4 of the third full-bridge inverter 23 are commonly connected to each other to constitute a positive terminal of the third full-bridge inverter 23. The other end of the series-connected switching elements S1 and S2 and the other end of the series-connected switching elements S3 and S4 of the third full-bridge inverter 23 are commonly connected to each other to constitute a negative terminal for the third full-bridge inverter 23.

The positive terminals of the first to third full-bridge inverters 21 to 23 are commonly connected to a positive terminal of the DC power source 4, and the negative terminals thereof are commonly connected to a negative terminal of the DC power source 4.

The DC power source 4 is operative to apply a DC voltage individually to each of the full-bridge inverters 21, 22, and 23.

In each of the first to third full-bridge inverters 21 to 23, the pair of switching elements S1 and S4 constitutes a first half-bridge, and the pair of switching elements S3 and S2 constitutes a second half-bridge.

Specifically, in the first full-bridge inverter 21, the first half-bridge and the second half-bridge are controlled to be alternately turned on with the DC voltage being applied across the positive and negative terminals of the first full-bridge inverter 21. This applies alternately a positive DC voltage and a negative DC voltage across the U-phase winding 11, in other words, applies a single-phase AC voltage across the U-phase winding 11.

Similarly, in the second full-bridge inverter 22, the first half-bridge and the second half-bridge are controlled to be alternately turned on with the DC voltage being applied across the positive and negative terminals of the second full-bridge inverter 22. This applies alternately a positive DC voltage and a negative DC voltage across the V-phase winding 12, in other words, applies a single-phase AC voltage across the V-phase winding 12.

In addition, in the third full-bridge inverter 23, the first half-bridge and the second half-bridge are controlled to be alternately turned on with the DC voltage being applied across the positive and negative terminals of the third fall-bridge inverter 23. This applies alternately a positive DC voltage and a negative DC voltage across the W-phase winding 13, in other words, applies a single-phase AC voltage across the W-phase winding 13.

The AC motor system 50 includes a rotational angle sensor 30, and current sensors 31, 32, and 33.

The rotational angle sensor 30 is arranged, for example, close to the rotor of the synchronous motor 1 and operative to measure an actual rotational angle (electric angle) θ of the d-axis of the rotor with respect to a stator coordinate system fixed in space which characterizes the three-phase windings 11, 12, and 13 of the stator. The rotational angle sensor 30 is communicable with the motor controller 3 and operative to send, to the motor controller 30, the measured actual rotation angle θ of the rotor as a motor state variable.

The current sensor 31 is arranged to allow measurement of an instantaneous U-phase current actually flowing through the U-phase winding 11 of the stator. Similarly, the current sensor 32 is arranged to allow measurement of an instantaneous V-phase current actually flowing through the V-phase winding 12 of the stator. The current sensor 33 is arranged to allow measurement of an instantaneous W-phase current actually flowing through the W-phase winding 13 of the stator.

The current sensors 31, 32, and 33 are communicable with the controller 3.

Specifically, each of the current sensors 31, 32, and 33 is operative to send, to the controller 3, the instantaneous value of a corresponding one of the U-, V-, and W-phase currents as some of the motor state variables.

The controller 3 is designed as, for example, a computer circuit consisting essential of, for example, a CPU, an I/O interface, and a memory unit

The controller 3 is communicable with a request torque input device 6 installed in the motor vehicle. The request torque input device 6 is operative to input, to the controller 3, a commanded torque (request torque) of a user, such as an acceleration command of the user.

For example, an accelerator position sensor installed in the motor vehicle can be used as the request torque input device 6. Specifically, the accelerator position sensor is operative to sense an actual position of an accelerator pedal of the motor vehicle operable by the driver and to send, as data representing a request torque of the driver, the sensed actual position of the accelerator pedal to the controller 3. The data representing a variable request torque will be referred to as “request torque data” hereinafter.

The switching elements S1 to S4 of each of the first to third full-bridge inverters 21 to 23 have control terminals connected to the drivers 5.

The drivers 5 are communicable with the controller 3.

The controller 3 is designed to carry out PWM (Pulse Width Modulation) control to switch each of the first to third full-bridge inverters 11 to 13 of the inverter circuit 2 in the same manner as a normal three-phase inverter for driving a normal delta-connected stator coil.

Specifically, under the PWM control, the controller 3 works to receive actual instantaneous U-, V-, and W-phase currents measured by the respective current sensors 31, 32, and 33, the actual rotational angle θ of the rotor measured by the rotational angular sensor 30, and the request torque data inputted from the request torque input device 6.

Based on the received actual instantaneous U-, V-, and W-phase currents, the received actual rotational angle θ of the rotor, and the received request torque data, the controller 3 works to, under the PWM control, calculate a single-phase AC command voltage, preferably a single-phase sinusoidal AC command voltage, for each of the U-, V-, and W-phase windings 11, 12, and 13. The single-phase sinusoidal AC command voltage is required to match the received actual instantaneous current for each of the U-, V-, and W-phase windings 11, 12, and 13 with a periodic command current, such as a sinusoidal command current corresponding to the request torque.

Under the PWM control, the controller 3 works to compare the single-phase sinusoidal AC command voltage for each of the U-, V-, and W-phase windings 11, 12, and 13 with a triangular (or saw-tooth) carrier wave.

Based on the result of the comparison, the controller 3 works to individually switch, via the corresponding drivers 5, on and off each of the first and second half-bridges of each of the first to third full-bridge inverters 21 to 23e. This modulates the DC voltage applied from the DC power source 4 across the positive and negative terminals of each of the first to third full-bridge inverters 21 to 23 into a single-phase AC voltage to be applied to each of the U-, V-, and W-phase windings 11, 12, and 13.

For example, for the first full-bridge inverter 21, the controller 3 causes the drivers 5 corresponding to the switching elements S1 to S4 of the first full-bridge inverter 21 to alternately switch:

the first half-bridge (S1 and S4) on while keeping the second half-bridge (S3 and S2) off; and

the second half-bridge (S3 and S2) on while keeping the first half-bridge (S1 and S4) off.

This applies alternately a positive DC voltage and a negative DC voltage across the U-phase winding 11, in other words, applies a single-phase AC voltage across the U-phase winding 11.

Adjustment of the on and off durations, that is, the duty (duty cycle) of each of the first half-bridge (S1 and S4) and the second half-bridge (S3 and S2) of the first full-bridge inverter 21 by the controller 3 matches the single-phase AC voltage to be applied to the U-phase winding 11 with the single-phase sinusoidal AC command voltage therefor.

Similarly, adjustment of the on and off durations, that is, the duty (duty cycle) of each of the first half-bridge (S1 and S4) and the second half-bridge (S3 and S2) of the second full-bridge inverter 22 by the controller 3 matches the single-phase AC voltage to be applied to the V-phase winding 12 with the single-phase sinusoidal AC command voltage therefor.

In addition, adjustment of the on and off durations, that is, the duty (duty cycle) of each of the first half-bridge (S1 and S4) and the second half-bridge (S3 and S2) of the third full-bridge inverter 23 by the controller 3 matches the single-phase AC voltage to be applied to the W-phase winding 13 with the single-phase sinusoidal AC command voltage therefor.

This matches the actual instantaneous current flowing through individually each of the U-, V-, and W-phase windings 11, 12, and 13 with the periodic command current therefor corresponding to the request torque. Thus, the actual instantaneous current flowing through individually each of the U-, V-, and W-phase windings 11, 12, and 13 causes the stator coil of the synchronous motor 1 to create a rotating magnetic field. The created rotating magnetic field generates a torque corresponding to the request torque relative to the rotor.

Next, advantages of the AC motor system 50 according to the first embodiment as compared with a conventional AC motor system in which a conventional three-phase inverter applies three-phase AC voltages to a conventional delta-connected stator coil.

Specifically, FIG. 2 schematically illustrates an example of the circuit structure of the conventional AC motor system in which the conventional three-phase inverter 20 applies three-phase AC voltages to the conventional delta-connected stator coil 21 consisting of delta-connected U-, V-, and W-phase stator windings 211, 212, and 213.

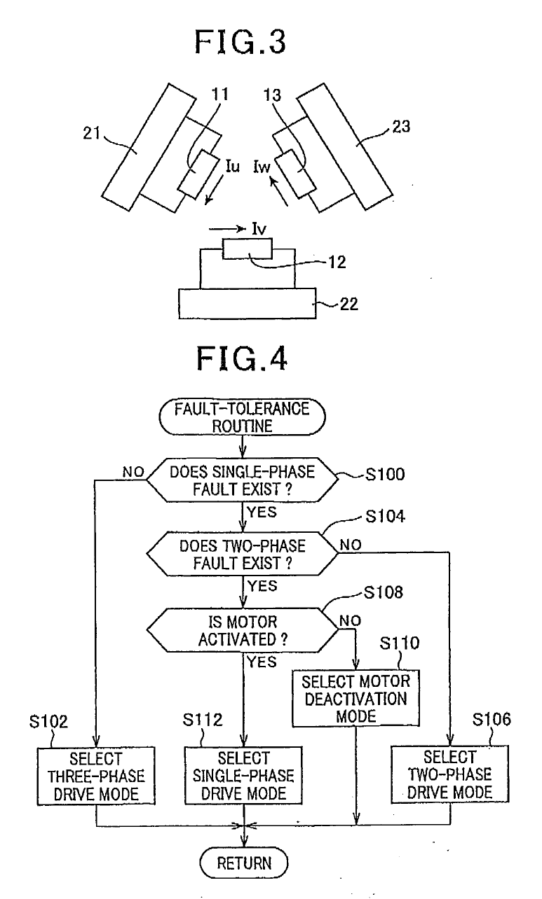

In contrast, FIG. 3 schematically illustrates the set of individually coupled U-phase winding 11 and first full-bridge inverter 21, the set of individually coupled V-phase winding 12 and second full-bridge inverter 22, and the set of individual coupled W-phase winding 13 and third full-bridge inverter 22.

In FIG. 2, reference characters Iu, Iv, and Iw represent U-, V-, and W-phase currents actually flowing through the U-, V-, and W-phase windings 211, 212, and 213, respectively. In FIG. 3, it is assumed that the same U-, V-, and W-phase currents In, Iv, and Iw actually flow through the U-, V-, and W-phase windings 11, 12, and 13, respectively.

As is well known, each of phase currents Ia, Ib, Ic of the inverter 20 for the three-phase windings 211, 212, 213 has an amplitude that is substantially 1.73 times as much as that of a corresponding one of U-, V-, and W-phase currents Iu, Iv, and Iw flowing respectively in the U-, V-, and W-phase windings 211, 212, and 213. In other words, the amplitude of each of the phase currents Ia, Ib, and Ic in the inverter 20 for the three-phase windings 211, 212, and 213 is \sqrt{3} times as much as that of a corresponding one of the U-, V-, and W-phase currents Iu, Iv, and Iw.

In contrast, the first full-bridge inverter 21, the second full-bridge inverter 22, and the third full-bridge inverter 23 of the inverter circuit 2 illustrated in FIG. 3 are configured to individually output the phase currents Iu, Iv, and Iw, respectively. Thus, each of the first to third full-bridge inverters 21 to 23 can be made up of power switching elements each having a current capacity substantially 1/1.73 times as much as a current capacity of each of power switching elements constituting the conventional inverter 20.

Note that the number of power switching elements required for each of the first to third full-bridge inverters 21 to 23 is three times as many as the number of power switching elements required for the one-phase half-bridge inverter of the conventional inverter 20. This means that two power switching elements used for one arm (upper or lower arm) of one phase of the inverter circuit 2 are parallelly connected to each other to provide one arm (upper or lower arm) of one phase of the conventional inverter 20.

It is assumed that the conventional inverter 20 illustrated in FIG. 2 consists of a total of 12 power switching elements that is the same as the number of power switching elements used for the inverter circuit 2. In this assumption, a current can be applied to the inverter circuit 2; this current has a magnitude substantially 2/1.73 tines as high as a magnitude of a current that can be applied to the inverter circuit 2.

In other words, in the assumption, the maximum current that can be applied to the inverter circuit 2 is reduced by approximately 14% than the maximum current that can be applied to the conventional inverter 20 for driving the delta-connected stator coil.

However, the inverter circuit 2 consisting of the first to third full-bridge inverters 21 to 23 achieves a specific advantage of individually controlling each of the U-, V-, and W-phase currents Iu, Iv, and Iw; this advantage cannot be achieved by the conventional inverter 20 illustrated in FIG. 2.

Note that the AC motor system 50 is made up of three-phase circuit systems each including a corresponding pair of one phase winding 11, 12, or 13 and one full-bridge inverter 21, 22, or 23.

Specifically, even in the case of a failure in one or two of the three-phase circuit systems, the individual current-control feature of the AC motor system 50 allows the remaining at least one normal phase circuit system to continuously drive the synchronous motor 1.

In other words, even in the case of a short-circuit or a break in one or two of the three-phase circuit systems, the AC motor system 50 allows the remaining at least one normal phase circuit system to continuously drive the synchronous motor 1 while operations of the one or two of the three-phase circuit systems are stopped.

Specifically, even in the case of: a short-circuit or a break in one phase circuit system, a break or an insufficient insulation in wires connecting between one full-bridge inverter and a corresponding phase winding of one phase circuit system, and/or a break or an insufficient insulation in one phase winding of one phase circuit system, the AC motor system 50 permits the remaining two normal phase circuit systems to continuously drive the synchronous motor 1.

That is, the AC motor system 50 according to the first embodiment improves the reliability of the synchronous motor 1 while keeping the reduction in the maximum current to a minimum level of the order of 15% as compared with a motor system with a conventional three-phase inverter illustrated in FIG. 2. The improvement of the reliability is very important in installing the AC motor system 50 in vehicles.

In addition, the inverter circuit 2 consisting of the first to third full-bridge inverters 21 to 23 prevents circulating currents to thereby reduce power loss and heat in the motor 1 due to the circulating currents; these circulating currents may be produced in delta-connected stator coils due to various nonlinear factors in the delta-connected stator coils. These advantages based on the prevention of circulating currents are very important in driving the synchronous motor 1 in a mode in which the sum of the phase currents flowing in the respective windings 11 to 13 is unequal to zero; this mode will be referred to as “non-rotationally symmetric mode”.

Note that, in FIG. 1, connection lines between the sensors and the controller 3 and those between the drivers 5 and the switching elements S1 to S4 can be omitted for simplification of illustration.

Next, operations of the AC motor system 50 will be described hereinafter.

A fault-tolerance routine to be executed by the controller 3 for various faults set forth above will be described hereinafter with reference to the flowchart illustrated in FIG. 4. The fault-tolerance routine is for example programmed to be carried out by the controller 3 each time a main routine for controlling the synchronous motor 1 is called to be carried out by the controller 3.

When starting the fault-tolerance routine, the controller 3 determines whether a single-phase fault or a two-phase fault exists in the AC motor system 50 based on the instantaneous phase currents measured by the respective current sensors 31, 32, and 33 in steps S100 and S104.

Note that the single-phase fault means a fault exists in one of the three-phase circuit systems set forth above, and no faults exist in the remaining two-phase circuit systems, that is, the remaining two-phase circuits operate normally. The two-phase fault means a fault simultaneously exists in two of the tree-phase circuit systems, and no faults exist in the remaining one-phase circuit system.

Note that faults described in the first embodiment include breaks, short-circuits, and insufficient insulation.

For example, in the first embodiment, the controller 3 stores therein a first threshold value for detecting breaks, a second threshold for detecting short-circuits, and a third threshold for detecting insufficient insulation of each of the three-phase circuit systems.

Specifically, in steps S100 and S104, the controller 3 compares the measured instantaneous phase current of each phase winding with each of the first and second thresholds, and compares a measured zero-phase current in each of the three-phase circuit systems with the third threshold. Note that the zero-phase current for one phase circuit system means a current flowing through strain capacitance between the earth and the one-phase circuit system, and the zero-phase current can be detected by a current sensor 53 illustrated by the phantom line, which can be installed in the AC motor system for each of the three-phase circuit systems.

In steps S100 and S104, based on a result of the comparison, the controller 3 determines whether a failure, such as a break, a short-circuit, and/or insufficient insulation exists in each of the three-phase circuit systems.

Upon determining that no faults exist in each of the three-phase circuit systems (NO in step S100), the controller 3 determines, as the operating mode for the synchronous motor 1, a three-phase drive mode in step S102, returning the main routine.

For a permanent magnet synchronous motor used as the synchronous motor 1 without using demagnetization control, in the three-phase drive mode of the main routine, the controller 3 carries out the PWM control set forth above to thereby apply, to the three-phase windings 11, 12, and 13, three-phase sinusoidal currents with a phase difference of, for example, 2π/3 between each other; the amplitude of each of the three-phase sinusoidal currents is in proportion to the request torque.

The three-phase sinusoidal currents to be applied to the three-phase windings 11, 12, and 13 provide a rotating magnetic field rotating at an angular velocity defined by the frequency of the three-phase sinusoidal currents. The rotating magnetic field provides a torque equivalent to the request torque to cause the rotor to rotate in synchronization therewith at the same angular velocity.

Otherwise, upon determining that a fault exists in only one of the three-phase circuit systems YES in step S100 and NO in step S104), the controller 3 determines, as the operating mode for the synchronous motor 1, a two-phase drive mode in step S106, returning the main routine.

In the two-phase drive mode of the main routine, the controller 3 carries out the PWM control to switch each of the remaining two full-bridge inverters corresponding to the remaining normal two-phase circuit systems to thereby apply two-phase AC voltages to two-phase winding corresponding to the normal two-phase circuit systems. This allows two-phase sinusoidal currents based on the two-phase AC voltages to be applied to two-phase windings corresponding to the remaining normal two-phase circuit systems provide a rotating magnetic field rotating at an angular velocity defined by the frequency of the three-phase sinusoidal currents. The rotating magnetic field provides a torque to cause the rotor to rotate in synchronization therewith at the same angular velocity,

Otherwise, upon determining that a fault exists in two of the three-phase circuit systems (YES in step S100 and YES in step S104), the controller 3 determines, based on the measured actual rotation angle θ of the rotor, whether the synchronous motor 1 is being driven in step S108.

Otherwise, upon determining that the synchronous motor 1 is not being driven (NO in step S108), the controller 3 determines, as the operating mode for the synchronous motor 1, a motor deactivation mode in step S110, returning the main routine.

In the motor deactivation mode of the main routine, the controller 3 maintains the synchronous motor 1 deactivated in the future in step S110.

Otherwise, upon determining that the synchronous motor 1 is being driven (YES in step S108), the controller 3 determines, as the operating mode or the sychronous motor 1, a single-phase drive mode in step S112, returning the main routine.

In the single-phase drive mode of the main routine, the controller 3 carries out the PWM control to switch the remaining one full-bridge inverter corresponding to the remaining normal phase circuit system to thereby apply a single-phase AC voltage to a corresponding one of the three-phase windings 11, 12, and 13 of the synchronous motor 1. This allows the synchronous motor 1 to be continuously driven as a single-phase AC motor.

Specifically, a single-phase sinusoidal current based on the single-phase AC voltage to be applied to the corresponding one of the three-phase windings 11, 12, and 13 provides a rotating magnetic field rotating at an angular velocity defined by the frequency of the single-phase sinusoidal current. The rotating magnetic field provides a torque to cause the rotor to rotate in synchronization therewith at the same angular velocity.

The operations in steps S108, S110, and S112 continuously drive the synchronous motor 1 as a single-phase motor even if a fault exists in two of the three-phase circuit systems. When the synchronous motor 1 used to drive the motor vehicle, a torque to be created by the synchronous motor 1 operating as a single-phase motor is lower than a starting torque required for the motor vehicle. For this reason, when the synchronous motor 1 is deactivated so that the motor vehicle is at a stop, it is possible to maintenance the synchronous motor 1 deactivated, thus reducing power loss and/or heat in the synchronous motor 1 due to redundant activations.

As described above, execution of the fault-tolerance routine achieves the improvement of the reliability of the synchronous motor 1 with minimum additional circuit-components as compared with conventional AC motor systems.

In addition, synchronous motors for generating vehicle driving torque are required to generate, for most of a driven duration, a torque within a normal range greatly lower than a preset maximum torque, and, for some of the driven duration, a torque within a specific range higher than the normal range. For example, when a motor vehicle in which such a synchronous motor is installed overtakes and passes another vehicle, the synchronous motor is required to generate a torque within the specific range higher than the normal range. Similarly, during start-up of a motor vehicle in which such a synchronous motor is installed, the synchronous motor is required to generate a torque within the specific range higher than the normal range.

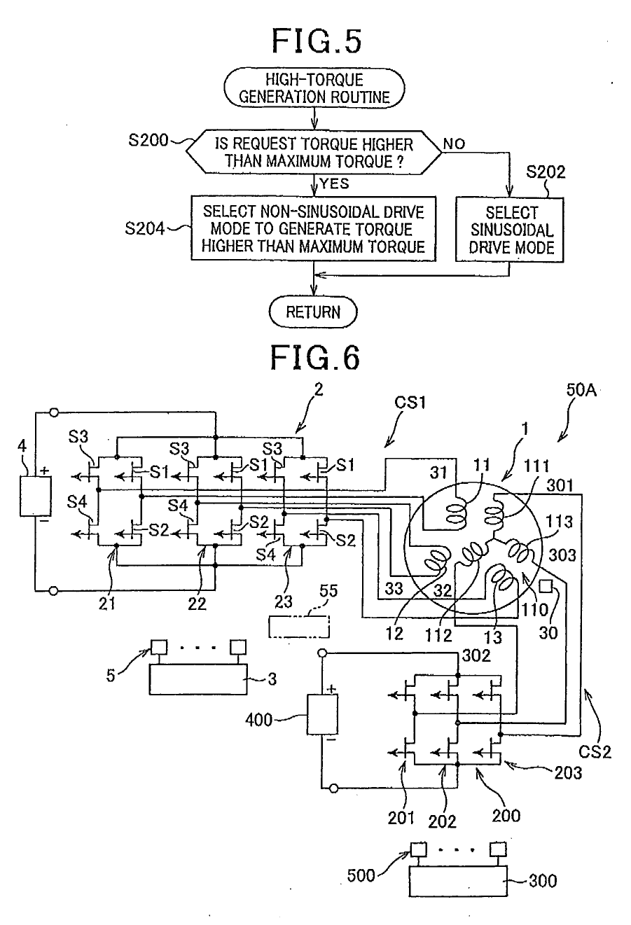

In order to achieve the higher-torque requirements, the controller 3 according to the first embodiment is programmed to execute a high-torque generation routine stored therein and illustrated in FIG. 5. For example, the controller 3 is programmed to execute the high-torque generation routine each time the controller 3 calls the main routine to carry out it

When starting the high-torque generation routine, the controller 3 determines whether the request torque based on the request torque data inputted from the request torque input device 6 is higher than a maximum torque that can be generated by the synchronous motor 1 when it is driven in a sinusoidal drive mode in step S200.

Upon determining that the inputted request torque is equal to or lower than the maximum torque (NO in step S200), the controller 3 determines, as the operating mode for the synchronous motor 1, the sinusoidal drive mode in step S202, returning the main routine.

In the sinusoidal drive mode, the controller 3 cares out the PWM control set forth above to thereby apply, to the three-phase windings 11, 12, and 13, sinusoidal three-phase currents with a phase difference of 2π/3 between each other; the amplitude of each of the three-phase sinusoidal three-phase currents is in proportion to the request torque.

Otherwise, upon determining that the inputted request torque is higher than the maximum torque (YES in step S200), the controller 3 determines, as the operating mode for the synchronous motor 1, a non-sinusoidal drive mode in step S204, returning the main routine.

In the non-sinusoidal drive mode, the controller 3 carries out the PWM control set forth above to thereby apply, to the three-phase windings 11, 12, and 13, three-phase currents each with a predetermined non-sinusoidal waveform; the three-phase currents each having a predetermined non-sinusoidal waveform that allows the synchronous motor 1 to generate a torque higher than the maximum torque.

The operations in steps S200, S202, and S204 permit the synchronous motor 1 to generate a torque higher than the maximum torque that can be generated by the synchronous motor 1 when it is driven in the sinusoidal drive mode.

How the torque to be created by the synchronous motor 1 being driven in the non-sinusoidal drive mode is increased will be detailedly described hereinafter for a reluctance motor with a salient-pole rotor for generating reluctance torque, such as an interior permanent magnet synchronous motor or a synchronous reluctance motor, used as the synchronous motor 1.

As well known, reluctance torque to be created by such a reluctance motor for each phase is proportional to the product of the square of a corresponding phase current in the reluctance motor and the absolute value of derivative of an inductance of a corresponding phase winding with respect to a rotational position of the rotor.

The inductance of each phase winding can be represented as a function of the rotational angle of the rotor. For this reason, the controller 3 can carry out the PWM control for the first to third full-bridge inverters 21 to 23 to thereby apply a non-sinusoidal phase current to each of the three-phase windings 11 to 13 during the phase period in which the absolute value of derivative of the inductance of a corresponding phase winding is higher than a preset value. The non-sinusoidal phase current is the sum of a fundamental sinusoidal current component and higher-order current components.

This allows the reluctance torque created by each of the energized windings 11 to 13 to increase.

The increase in the reluctance torque created by a phase winding by an application of a phase current with a non-sinusoidal waveform to the phase winding has been well known to those of skill in the art.

In addition, in permanent magnet synchronous motors, magnet torque in the d-q coordinate system (rotating coordinate system) is represented as the product of the flux of permanent magnets and a q-axis current. The increase in the average value of a q-axis current by change of the sinusoidal waveform of a phase current to a non-sinusoidal waveform, such as a trapezoidal waveform, with the same amplitude has also be well known to skilled persons in the art.

Thus, in the first embodiment, when the inputted request torque is higher than the maximum torque that can be generated by the synchronous motor 1 when it is driven in the sinusoidal drive mode (S in step S200), the sinusoidal waveform of each of the phase currents Iu, Iv, and Iw to be applied to the respective phase windings 11, 12, and 13 is changed to a non-sinusoidal waveform close to the trapezoidal waveform with the same amplitude. Each of the energized windings 11, 12, and 13 based on the non-sinusoidal phase currents increases the torque created by the synchronous motor 1.

Because either the start-up of the motor vehicle in which the synchronous motor 1 is installed or the speed-up of the motor vehicle to pass another vehicle is carried out in a temporary short time, the advantage of increasing the torque created by the synchronous motor 1 is greater than the disadvantage of increasing torque ripples, vibrations, or noise.

Thus, the AC motor system 50 according to the first embodiment provides a higher torque while preventing increase in the size of the DC power source 4 as compared with conventional AC motor systems. Specifically, because conventional AC motors each with star- or delta-connected stator windings causes the sum of three-phase currents to become zero, it may be difficult to apply, to each phase winding, a non-sinusoidal phase current most suitable for each phase winding.

As described above, the AC motor system 50 according to the first embodiment is made up of:

the three-phase windings 11, 12, and 13 that are electrically isolated from each other; and

the inverter circuit 2 consisting of the first to third full-bridge inverters 21, 22, and 23 each of which is configured to individually apply a single phase voltage to a corresponding one of the three-phase windings 11, 12, and 13.

Specifically, the AC motor system 50 provides three full-bridge inverters 21, 22, and 23 as the inverter circuit 2 for the electrically isolated three-phase windings. Each of the full-bridge inverters 21, 22, and 23 consists of, as a first half-bridge, a pair of series-connected switching elements S1 and S2 and, as a second half-bridge, a second pair of series-connected switching elements S3 and S4; these first and second half-bridges are parallelly connected to each other. Each of the full-bridge inverters 21 to 23 is operative to individually drive a corresponding one of the three-phase windings 21 to 23.

The configuration of the AC motor system 50 allows a set of one phase winding and a corresponding one full-bridge inverter to be electrically little affected from the remaining two sets of two-phase windings and corresponding two full-bridge inverters. Thus, the AC motor system 50 achieves the first advantage of improving the reliability of the synchronous motor 1 while keeping the increase in the manufacturing cost of the inverter circuit 2.

The AC motor system 50 according to the first embodiment is configured to determine whether a fault exists in each of the three-phase circuit systems each consisting of one phase winding, one full-bridge inverter, and wires connecting therebetween.

Upon determining a fault exists in one-phase circuit system, the AC motor system 50 is configured to completely stop the operations of one full-bridge inverter of the failed one-phase circuit system, and to cause the remaining two full-bridge inverters to apply two-phase AC voltages to corresponding two-phase windings. This continuously drives the synchronous motor 1 even in the event of a fault of one-phase circuit system. Thus, the AC motor system 50 achieves the second advantage of improving the reliability of the synchronous motor 1 even in the event of a failure of one-phase circuit system.

The AC motor system 50 according to the first embodiment is configured to determine whether a fault exists in two of the three-phase circuit systems.

Upon determining a fault exists in each of the two-phase circuit systems, the AC motor system 50 is configured to completely stop the operations of two full-bridge inverters of the failed two-phase circuit systems, and to cause the remaining one full-bridge inverter to apply a single-phase AC voltage to a corresponding one-phase winding. This continuously drives the synchronous motor 1 even in the event of a fault of each of two-phase circuit systems. Thus, the AC motor system 50 achieves the third advantage of improving the reliability of the synchronous motor 1 even in the event of a failure of each of two-phase circuit systems.

The first to third full-bridge inverters 21 to 23 of the inverter circuit 2 are operative to individually apply, to the three-phase windings 11 to 13, three-phase sinusoidal AC voltages with a preset phase difference between each other. As compared with a conventional three-phase inverter for applying three-phase sinusoidal AC voltages to star-connected phase windings of a synchronous motor, it is possible for the inverter circuit 2 to increase the level of three-phase AC voltages to be applied to the three-phase windings 11 to 13. This can increase the number of turns of each of the three-phase windings 11 to 13 so as to reduce each of the three-phase currents without reducing torque to be created by the three-phase windings 11 to 13. This achieves the fourth advantage of reducing copper loss due to the three-phase currents to be applied to the three-phase windings 11 to 13.

The configuration of the inverter circuit 2 also achieves the fifth advantage of preventing circulating currents to thereby reduce power loss and heat in the synchronous motor 1 due to the circulating currents.

With the configuration of the AC motor system 50, the vector sum of the three-phase voltages to be outputted from the first to third full-bridge inverters 21 to 23 is unequal to zero.

Specifically, the AC motor system 50 according to the first embodiment is adapted to individually control the first to third full-bridge inverters 21 to 23 to thereby apply, to each of the three-phase windings 11 to 13, a phase current most suitable thereto as the sixth advantage thereof.

In contrast, conventional AC motors each with star- or delta-connected stator windings cannot inherently apply, to each of the star- or delta-connected stator windings 11 to 13, a phase current most suitable thereto. This is because the vector sum of the three-phase voltages to be outputted from a conventional three-phase inverter becomes zero.

When a torque higher the maximum torque that can be created by the synchronous motor 1 when it is driven by three-phase sinusoidal phase currents, the AC motor system SO works to apply, to the three-phase windings 11 to 13, three-phase currents. Each of the applied three-phase currents has a predetermined non-sinusoidal waveform that allows the synchronous motor 1 to generate a torque higher than the maximum torque.

In contrast, when it is required to reduce torque ripples, the. AC motor system 50 works to apply, to the three-phase windings 11 to 13, sinusoidal three-phase currents.

In order to further reduce torque ripples, vibrations, and noises, the AC motor system 50 can individually superimpose, on each phase current to be applied to a corresponding one phase winding, higher-order components opposite in phase to higher-order currents that cause such torque ripples, vibrations, and noises.

### Second Embodiment

An AC motor system 50A according to the second embodiment of the present invention will be described hereinafter with reference to FIG. 6.

The structure of the AC motor system 50A according to the second embodiment is substantially identical to that of the AC motor system 50 according to the first embodiment except for the following different points. So, like parts between the AC motor systems 50 and 50A according to the first and second embodiments, to which like reference characters are assigned, are omitted or simplified in description.

In addition to the components of the AC motor system 50, the AC motor system 50A includes a star-connected stator coil 110, a three-phase inverter 200, a motor controller 300, a DC power source 400, and a plurality of drivers 500.

The star-connected stator coil 110 consists of a U-phase winding 111, a V-phase stator winding 112, and a W-phase stator winding 113. The three-phase windings 111, 112, and 113 are wound in the slots of the stator such that:

the U-, V-, and W-phase windings 111, 112, and 113 are arranged to be spatially identical to the U-, V-, and W-phase windings 11, 12, and 13 or

the U-, V-, and W-phase windings 111, 112, and 113 are arranged to be spatially symmetric with respect to the U-, V-, and W-phase windings 11, 12, and 13 to form six phase windings.

The three-phase inverter 200 is provided with a first half-bridge consisting of a pair of series-connected high- and low-side switching elements S11 and S12, a second half-bridge consisting of a pair of series-connected high- and low-side switching elements S11 and S12, and a third half-bridge consisting of a pair of series-connected high- and low-side switching elements S11 and S12. When IGBTs are used as the switching elements S11 and S12, flywheel diodes (not shown) are provided to be electrically connected in antiparallel to the switching elements S11 and S12 of each half-bridge.

When power MOSFETs are used as the switching elements S11 and S12, intrinsic diodes of the power MOSFETs can be used as the flywheel diodes, thus eliminating the flywheel diodes.

The first to third half-bridges 201, 202, and 203 are parallelly connected to each other in bridge configuration.

A connecting point through which the switching elements S11 and S12 of each of the half-bridges 201, 202, and 230 are connected to each other in series is connected to an output lead extending from the other end of a corresponding one of the U-, V-, and W-phase winding 111, 112, and 113.

One end of each of the first to third half-bridges 201, 202, and 203 is connected to a positive terminal of the DC power source 400, and the other end thereof is connected to a negative terminal of the DC power source 400. The power source 4 can serve as the DC power source 400 to be shared between the inverter circuits 2 and 200.

The AC motor system 50A includes current sensors 301, 302, and 303.

The current sensor 301 is arranged to allow measurement of an instantaneous U-phase current actually flowing through the U-phase winding 111 of the stator. Similarly, the current sensor 302 is arranged to allow measurement of an instantaneous V-phase current actually flowing through the V-phase winding 112 of the stator. The current sensor 303 is arranged to allow measurement of an instantaneous W-phase current actually flowing through the W-phase winding 113 of the stator.

The current sensors 301, 302, and 303 are communicable with the controller 300.

Specifically, each of the current sensors 301, 302, and 303 is operative to send, to the controller 300, the instantaneous value of a corresponding one of the U-, V-, and W-phase currents as some of the motor state variables.

The controller 300 is designed as, for example, a computer circuit consisting essentially of, for example, a CPU, an I/O interface, and a memory unit.

The controller 300 is communicable with the controller 3 and the request torque input device 6. The switching elements S11 and S12 of each of the first to third half-bridges 201 to 203 have control terminals connected to the drivers 500.

The drivers 500 are communicable with the controller 300.

As well as the first embodiment, the AC motor system 50A is made up of three-phase circuit systems each including a corresponding pair of one phase winding 111, 112, or 113 and one half-bridges 201, 202, or 203. The three-phase circuit systems each including a corresponding pair of one phase winding 11, 12, or 13 and one full-bridge inverter 21, 22, or 23 will be referred to as “first three-phase circuit systems CS1”. The three-phase circuit systems each including a corresponding pair of one phase winding 111, 112, or 113 and one half-bridges 201, 202, or 203 will be referred to as “second three-phase circuit systems CS2”.

For example, in the second embodiment, the request torque is allocated between the first and second three-phase circuit systems.

Specifically, the controller 3 is designed to carry out PWM control to switch each of the first to third full-bridge inverters 11 to 13 of the inverter circuit 2 to thereby generate a part of the request torque allocated for the first three-phase circuit systems CS1.

The controller 300 is designed to carry out PWM control to switch the switching elements S1 and S2 of each of the first to third half-bridges 201 to 203 of the inverter circuit 200 to thereby generate the remaining part of the request torque allocated for the second three-phase circuit systems CS2.

Other operations of the AC motor system 50A according to the second embodiment are substantially identical to those of the AC motor system 50 according to the first embodiment.

As described above, the AC motor system 50A according to the second embodiment is equipped with:

the first three-phase circuit systems CS1 consisting of the set of the inverter circuit 2 and the three-phase windings 11, 12, and 13; and

the second three-phase circuit systems CS2 consisting of the set of the inverter circuit 200 and the three-phase windings 111, 112, and 113.

With the configuration of the AC motor system 50A, even if a fault exists in at least one of the first three-phase circuit systems CS1, it is possible to continuously drive the synchronous motor 1 by the second three-phase circuit systems CS2 and at least one of the first three-phase circuit systems CS1 if it is normal. Similarly, even if a fault exists in at least one of the second three-phase circuit systems CS2, it is possible to continuously drive the synchronous motor 1 by the first three-phase circuit systems CS1 and at least one of the second three-phase circuit systems CS2 if it is normal.

Even if a fault exists in at least one of the first three-phase circuit systems CS1 and at least one of the second three-phase circuit systems CS2, it is possible to continuously drive the synchronous motor 1 by at least one of the first three-phase circuit systems CS1 and at least one of the second three-phase circuit systems CS2 if they are normal.

Thus, AC motor system 50A achieves the seventh advantage of, in addition to the first to sixth advantages, improving the reliability of the synchronous motor 1 even in the event of a failure of either at least one of the first three-phase circuit systems CS1 or at least one of the second three-phase circuit systems CS2.

In each of the first and second embodiments, the number of multiphase windings each phase winding of which is individually provided in the stator is three, but the present invention is not limited thereto. Specifically, N-phase windings (N is an integer greater than three) can be individually provided in the stator, and an inverter circuit consisting of first, second, . . . , and N-th full-bridge inverters can be provided for driving the N-phase windings, respectively.

In each of the first and second embodiments, the present invention is applied to synchronous motors, but can be applied to AC rotating machine equipped with N-phase windings and N-th full-bridge inverters for driving the N-phase windings, respectively.

While there has been described what is at present considered to be the embodiments and their modifications of the present invention, it will be understood that various modifications which are not described yet may be made therein, and it is intended to cover in the appended claims all such modifications as fall within the scope of the invention.

What is claimed is:

1. An alternating current (AC) rotating machine comprising:
a rotor;
a stator provided with N-phase stator windings and located relative to the rotor, the N being an integer equal to or greater than 3, the N-phase stator windings being arranged to be electrically isolated from each other; and
an inverter circuit provided with first to N-th full-bridge inverters, each of the first to N-th full-bridge inverters comprising a first pair of series-connected switching elements and a second pair of series-connected switching elements, the first pair of series-connected switching elements and the second pair of series-connected switching elements being connected in parallel to each other, each of the first to N-th full-bridge inverters being configured to individually apply a single-phase AC voltage to a corresponding one of the N-phase stator windings to thereby create a torque that rotates the rotor.

2. The AC rotating machine according to claim 1, wherein the N is three, the N-phase stator windings are three-phase stator windings, the inverter circuit is provided with the first to third full-bridge inverters, and each of the first to third full-bridge inverters is configured to individually apply the single-phase AC voltage to a corresponding one of the three-phase stator windings.

3. The AC rotating machine according to claim 2, wherein the three-phase stator windings are first-, second-, and third-phase stator windings, the first-phase stator winding and the first full-bridge inverter are connected to each other to constitute a first-phase circuit system, the second-phase stator winding and the second full-bridge inverter are connected to each other to constitute a second-phase circuit system, and the third-phase stator winding and the third full-bridge inverter are connected to each other to constitute a third-phase circuit system, further comprising:
a fault determining unit configured to determine whether a fault exists in one of the first to third-phase circuit systems; and
a control unit that:
deactivates one of the first to third full-bridge inverters when it is determined that the fault exists in the one of the first to third-phase circuit systems, the one of the first to third full-bridge inverters corresponding to the one of the first to third-phase circuit systems in which the fault exists; and
causes the remaining two of the first to third full-bridge inverters to continuously apply the single-phase AC voltages to corresponding two of the three-phase stator windings except for one-phase stator winding, the one-phase stator winding being included in the one of the first to third-phase circuit systems.

4. The AC rotating machine according to claim 2, wherein the three-phase stator windings are first-, second-, and third-phase stator windings, the first-phase stator winding and the first full-bridge inverter are connected to each other to constitute a first-phase circuit system, the second-phase stator winding and the second full-bridge inverter are connected to each other to constitute a second-phase circuit system, and the third-phase stator winding and the third full-bridge inverter are connected to each other to constitute a third-phase circuit system, further comprising:
a fault determining unit configured to determine whether a fault exists in two of the first to third-phase circuit systems; and
a control unit that:
deactivates two of the first to third full-bridge inverters when it is determined that the fault exists in the two of the first to third-phase circuit systems, the two of the first to third full-bridge inverters corresponding to the two of the first to third-phase circuit systems in which the fault exists; and
causes the remaining one of the first to third full-bridge inverters to continuously apply the single-phase AC voltage to corresponding one of the three-phase stator windings except for two-phase stator windings, the two-phase stator windings being included in the two of the first to third-phase circuit systems.

5. The AC rotating machine according to claim 2, wherein the first to third full-bridge inverters are configured to individually apply the single-phase AC voltages to the three-phase stator windings, respectively, the single-phase AC voltages are shifted by a predetermined electric angle in phase from each other to constitute three-phase AC voltages.

6. The AC rotating machine according to claim 2, wherein the first to third full-bridge inverters are configured to individually apply the single-phase AC voltages to the three-phase stator windings, respectively, such that a vector sum of the single-phase AC voltages applied from the respective first to third full-bridge inverters is unequal to zero.

7. The AC rotating machine according to claim 6, wherein the rotor and the stator constitute a synchronous motor in which the rotor is rotated in synchronization with a rotating magnetic field, the rotating magnetic field being generated by the three-phase stator windings to which the single-phase AC voltages are individually applied, respectively.

8. The AC rotating machine according to claim 7, wherein the synchronous motor is a reluctance motor with a salient-pole structure, the torque created by the three-phase stator windings to which the single-phase AC voltages are individually applied, respectively, is a sychronous reluctance torque based on the salient-pole structure, and each of the first to third full-bridge inverters is configured to apply a non-sinusoidal phase current based on the single-phase AC voltage to each of the three-phase stator windings during a preset phase period in which an absolute value of derivative of an inductance of a corresponding phase winding is higher than a preset value, the non-sinusoidal phase current being the sum of a fundamental sinusoidal current component and higher-order current components.

9. An AC rotating machine comprising:
a rotor;
a stator provided with first N-phase stator windings and second N-phase stator windings, the stator being located relative to the rotor, the N being an integer equal to or greater than 3, the first N-phase stator windings being arranged to be electrically isolated from each other;
a first inverter circuit provided with first to N-th full-bridge inverters for the first N-phase stator windings; and
a second inverter circuit provided with first to N-th inverters for the second N-phase stator windings, each of the first to N-th full-bridge inverters of the first inverter circuit comprising a first pair of series-connected switching elements and a second pair of series-connected switching elements, the first pair of series-connected switching elements and the second pair of series-connected switching elements being connected in parallel to each other, each of the first to N-th full-bridge inverters of the first inverter circuit being configured to individually apply a single-phase AC voltage to a corresponding one of the first N-phase stator windings to energize the first N-phase stator windings, the first to N-th inverters of the second inverter circuit being configured to apply N-phase AC voltages to the second N-phase stator windings to energize the second N-phase stator windings, respectively, the energized first N-phase stator windings and the energized second N-phase stator windings creating a torque that rotates the rotor.
